(19) United States
(12) Patent Application Publication
(10) Pub. No.: US 2026/0012797 A1
(43) Pub. Date: Jan. 8, 2026

(54) VERIFICATION OF SIM PRESENCE AT REPRESENTED LOCATION

(71) Applicant: T-Mobile USA, Inc., Bellevue, WA (US)

(72) Inventors: William WHEAT, Greenbank, WA (US); Rahul Raj, Bellevue, WA (US)

(21) Appl. No.: 18/764,086

(22) Filed: Jul. 3, 2024

(51) Int. Cl. H04W 12/40; G06K 7/14

(52) U.S. Cl. CPC H04W 12/40; G06K 7/1417

(57) ABSTRACT

Verification of a subscriber identity module (SIM), as represented by the purported owner, is enabled without requiring that the SIM be removed from a user equipment (UE, e.g., a cellphone). The UE scans a code (e.g., a QR code) that contains an address of a verification website and an interaction identifier (ID) that includes a session ID, a UE identification (e.g., a phone number) as reported by the purported owner, and a time that indicates a session expiration. The UE transmits the interaction ID to the website, and also must transmit its own IP address in order to receive the website's response. The website has a list, previously compiled by the cellular service provider, that pairs IP addresses with UE identifications (e.g., phone numbers). The information transmitted by the UE is compared with the list to verify that the UE that scanned the code actually has the SIM, as represented.

### BACKGROUND

Social engineering enables cyber attacks that permit bad actors to make changes on a victim's cellular service account. A one time PIN, sent to the victim's cellphone (e.g., in a text message) is used a proxy for verifying the identity of the person who purports to be the owner of the account. What is truly being verified in this arrangement, however, is the presence of the subscriber identity module (SIM), because the SIM can be moved around among different cellphones. It is the SIM that determines which cellphone (or user equipment, UE) that receives the one time PIN.

Unfortunately, a 2-actor man-in-the-middle attack is able to defeat a one time PIN identity verification scheme. One scenario uses the following ploy: The first actor enters a retail facility of the cellular service provider, pretending to be the victim, and initiates an action (e.g., a change of the victim's account with the organization, such as adding or removing certain services). The service provider transmits a one time PIN to the victim (e.g., by text message to the victim's cellphone) to use for the identity verification.

The second actor is in contact with the victim and tricks the victim into revealing the one time PIN, such as by pretending to be an employee of the service provider. Upon obtaining the one time PIN from the victim, the second actor covertly relays the one time PIN to the first actor, who provides it to a real employee of the service provider within the retail facility. The employee of the service provider is then misled into believing that the first actor is the victim.

As an alternative, the employee of the service provider may request that a threat actor display a screen on the cellphone that displays the integrated circuit card identification number (ICCID), which is an 18 to 22-digit unique serial number that identifies the SIM card. However, the threat actor could instead display a screenshot that was obtained from the victim by another ruse.

### SUMMARY

The following summary is provided to illustrate examples disclosed herein, but is not meant to limit all examples to any particular configuration or sequence of operations.

Solutions are disclosed that enable verification of the presence of a subscriber identity module (SIM) at the location that is represented by the purported owner, without requiring that the SIM be removed from the user equipment (UE). Examples scan, by a UE, a first scannable code; extract, by the UE, an internet protocol (IP) address of a verification website and an interaction identifier (ID) from the first scannable code; using the extracted IP address of the verification website, transmit, by the UE, to the verification website, the interaction ID and a reported IP address of the UE; extract, by the verification website, from the interaction ID, a session ID, a reported UE identification, and a first time indicator; using the first time indicator, determine that the session ID is not expired; based on at least determining that the session ID is not expired, determine that the reported IP address of the UE matches a stored IP address within a first SIM, wherein determining that the reported IP address of the UE matches the stored IP address within the first SIM comprises: using the reported UE identification and an association, within a SIM address list, between a stored UE identification and the stored IP address within the first SIM, to identify the stored IP address within the first SIM; based on at least determining that the reported IP address of the UE does match the stored IP address within the first SIM, generate a verification ID comprising the session ID, the reported UE identification, a verification confirmation, and a second time indicator; and transmit, by the verification website, to the UE, using the reported IP address of the UE, the verification ID.

Additional examples scan, by a UE, a first scannable code; extract, by the UE, an IP address of a verification website and an interaction ID from the first scannable code; using the extracted IP address of the verification website, transmit, by the UE, to the verification website, the interaction ID and a reported IP address of the UE; extract, by the verification website, from the interaction ID, a session ID, a reported UE identification, a terminal identification of a remote terminal, and a first time indicator; using the first time indicator, determine that the session ID is not expired; based on at least determining that the session ID is not expired, determine whether the reported IP address of the UE matches a stored IP address within a first SIM, wherein determining whether the reported IP address of the UE matches the stored IP address within the first SIM comprises: use the reported UE identification and an association, within a SIM address list, between a stored UE identification and the stored IP address within the first SIM, to identify the stored IP address within the first SIM; and based on at least determining that the reported IP address of the UE does match the stored IP address within the first SIM, transmit, by the verification website, to the terminal, using the terminal identification, a first verification message indicating that the UE passed a SIM verification.

### BRIEF DESCRIPTION OF THE DRAWINGS

The disclosed examples are described below with reference to the accompanying drawing figures listed below, wherein:

FIG. 1 illustrates an exemplary architecture that advantageously enables verification of the presence of a subscriber identity module (SIM) within a user equipment (UE);

FIG. 2 illustrates an exemplary verification scenario, as may be used in examples of the architecture of FIG. 1;

FIG. 3A illustrates a flowchart of exemplary operations associated with the architecture of FIG. 1;

FIG. 3B illustrates a flowchart of exemplary operations associated with a first verification scenario, and which follows the operations of the flowchart of FIG. 3A;

FIG. 3C illustrates a flowchart of exemplary operations associated with an alternative verification scenario, and which also follows the operations of the flowchart of FIG. 3A, in lieu of FIG. 3B;

FIG. 4 illustrates further detail for a terminal used for verification in examples of the architecture of FIG. 1;

FIG. 5 illustrates further detail for the UE of FIG. 1;

FIG. 6 illustrates further detail for a remote website used for verification in examples of the architecture of FIG. 1;

FIGS. 7 and 8 illustrate flowcharts of exemplary operations associated with the architecture of FIG. 1; and

FIG. 9 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed that enable verification of the presence of a subscriber identity module (SIM), as represented by the purported owner, without requiring that the SIM be removed from a user equipment (UE) such as a cellphone. The UE scans a code, such as a QR code, which holds an address of a verification website and an interaction identifier (ID) that includes a session ID, a UE identification (e.g., a phone number) as reported by the purported owner, and a time that indicates a session expiration. The UE transmits the interaction ID to the website, and also must transmit its own IP address in order to receive the website's response. The website has a list, previously compiled by the cellular service provider, that pairs IP addresses with UE identifications (e.g., phone numbers). The information transmitted by the UE is compared with the list to verify that the UE that scanned the code has the SIM, as represented.

Aspects of the disclosure improve the performance of cellular networks by enabling trust in a purported cellular service account owner, in a relatively easy manner, such as without requiring removal of a SIM from a UE. The approaches taught herein are more resistant to cyber attacks than the traditional one time PIN security solution. These advantageous results are accomplished, at least in part, by transmitting, by a UE, to a verification website, an interaction ID and a reported IP address of the UE, wherein the interaction ID comprises a session ID, a reported UE identification, and a first time indicator.

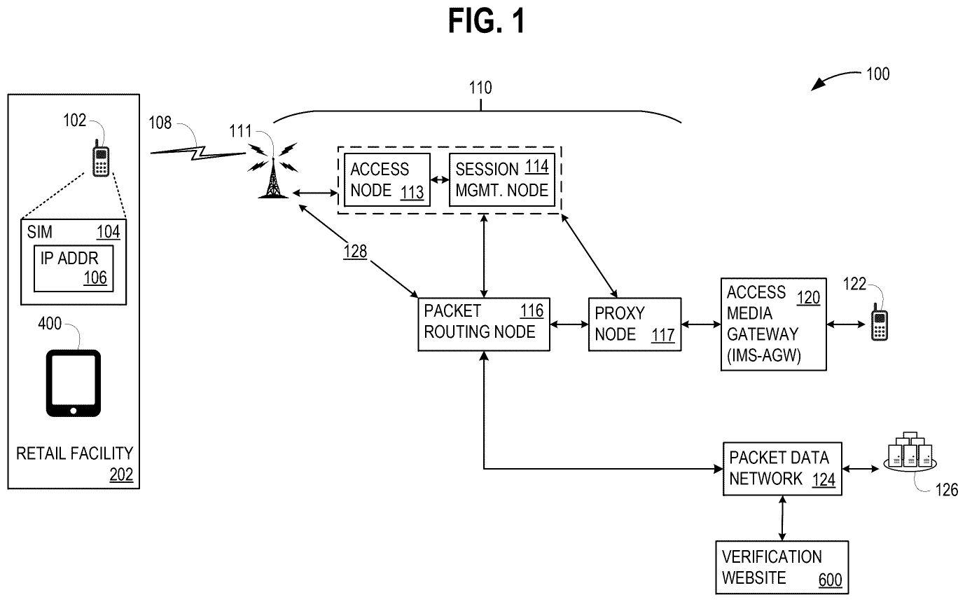

With reference now to the figures, FIG. 1 illustrates an exemplary architecture 100 that advantageously enable verification of the presence of a SIM, as is represented by the purported owner, without requiring that the SIM be removed from the UE. A wireless network 110 is illustrated that is serving a UE 102. UE 102 may be an enhanced Mobile Broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network. In the scene depicted in FIG. 1, UE 102 is using wireless network 110 for a packet data session to reach a network resource 126 (e.g., a website) across an external packet data network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

UE 102 uses an air interface 108 to communicate with a base station 111 of wireless network 110, such that base station 111 is the serving base station for UE 102 (providing the serving cell). In some scenarios, base station 111 may be referred to as a radio access network (RAN). Wireless network 110 has an access node 113, a session management node 114, and other components (not shown). Wireless network 110 also has a packet routing node 116 and a proxy node 117. Access node 113 and session management node 114 are within a control plane of wireless network 110, and packet routing node 116 is within a data plane (a.k.a. user plane) of wireless network 110.

Base station 111 is in communication with access node 113 and packet routing node 116. Access node 113 is in communication with session management node 114, which is in communication with packet routing node 116 and proxy node 117. Packet routing node 116 is in communication with proxy node 117 and packet data network 124. In some 5G examples, base station 111 comprises a gNodeB (gNB), access node 113 comprises an access mobility function (AMF), session management node 114 comprises a session management function (SMF), and packet routing node 116 comprises a user plane function (UPF).

In some 4G examples, base station 111 comprises an eNodeB (eNB), access node 113 comprises a mobility management entity (MME), session management node 114 comprises a system architecture evolution gateway (SAEGW) control plane (SAEGW-C), and packet routing node 116 comprises an SAEGW-user plane (SAEGW-U). In some examples, proxy node 117 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

Proxy node 117 is in communication with an internet protocol (IP) multimedia system (IMS) access gateway (IMS-AGW) 120 within an IMS, in order to provide connectivity to other wireless (cellular) networks, such as for a call with a UE 122 or a public switched telephone system (PSTN, also known as plain old telephone system, POTS). In some examples, proxy node 117 may be considered to be within the IMS. UE 102 reaches network resource 126 using packet data network 124 (or the IMS, in some examples). Data packets of data traffic 128 to/from UE 102 pass through at least base station 111 and packet routing node 116 on their way from/to packet data network 124 or IMS-AGW 120 (via proxy node 117).

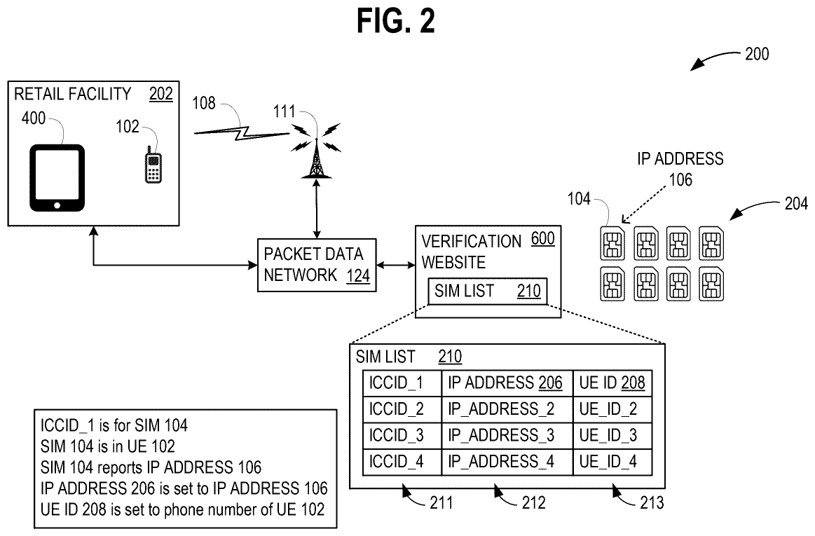

In a verification scenario, illustrated in further detail in FIG. 2 and described more fully below, in relation to the other figures, UE 102 has a SIM 104 that holds an IP address 106. UE 102 is within a retail facility 202. An employee of the cellular service provider, that operates wireless network 110, is using a terminal 400 within retail facility 202. Terminal 400 may be, for example, a tablet computer. A verification website 600 provides verification functionality so that the employee of the cellular service provider, located in retail facility 202, is able to trust that the purported owner of UE 102 has actually brought SIM 104 into retail facility 202. This is a proxy for trusting that the purported owner of UE 102 is actually the cellular service account owner. Terminal 400 reaches verification website 600 by any practical means, WiFi, cellular, or even a wired connection.

Although FIG. 1 and some of the following figures are described using an example of a cellular network, it should be understood that the teachings herein are applicable to other types of wireless networks. To benefit from the teachings herein, another service provider, beyond a cellular service provider, that manages accounts for its customers should have usage privileges for verification website 600, or otherwise have access to a SIM address list 210 (described below, in relation to FIG. 2). With such privilege or data access, another type of service provider, other than a cellular network, may also benefit from the disclosure herein.

FIG. 2 illustrates an exemplary verification scenario 200. The cellular service provider provisions a plurality of SIMs 204 for its customers, such as by loading them with unique IP addresses, and generating SIM address list 210. The SIMS of plurality of SIMs 204 may each be a physical SIM card (pSIM) or an embedded SIM (eSIM). SIM address list 210 is shown in the form of a table with three columns: ICCIDs 211 that each uniquely reference a SIM, stored IP addresses 212 (at least one per SIM), and stored UE identifications 213 (at least one per UE). In some scenarios, the IP addresses assigned to plurality of SIMs 204 are rotated, although remain unique. IP address rotation is a process in which the IP address of a device (i.e., its unique identifier on an IP network) changes at scheduled intervals, after a certain amount of requests, or on some other trigger event. Stored UE identifications 213 may be phone numbers, in some examples.

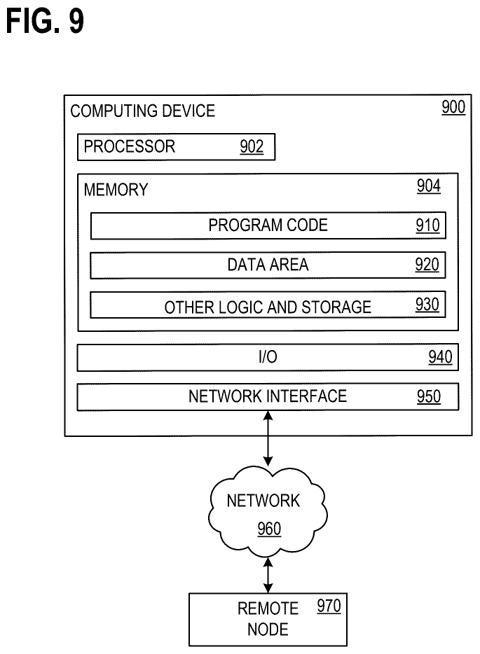

Each row of SIM address list 210 is unique to a SIM, as shown. SIM 104 is represented within SIM address list 210, specifically by a stored IP address 206 and a stored UE identification 208. Stored IP address 206 is set to the same value as IP address 106, and stored UE identification 208 is set to the phone number (or some other suitable identification) of UE 102. A copy of SIM address list 210 is accessible by verification website 600, located across packet data network 124 from retail facility 202. In some examples, verification website 600 is another example of network resource 126 of FIG. 1, and packet data network 124 is an example of external network 960 of FIG. 9.

UE 102 is brought into retail facility 202 so that the owner of UE 102, who is the cellular service account owner for the cellular plan that defines the service for UE 102 is able to make account changes. The account changes may be adding a new line, removing a line, changing a data plan, or another change. An employee of the cellular service provider, who is using terminal 400 the needs to verify that the person entering retail facility 202 is truly the cellular service account owner (or another person who is on the account and authorized to make changes to the account).

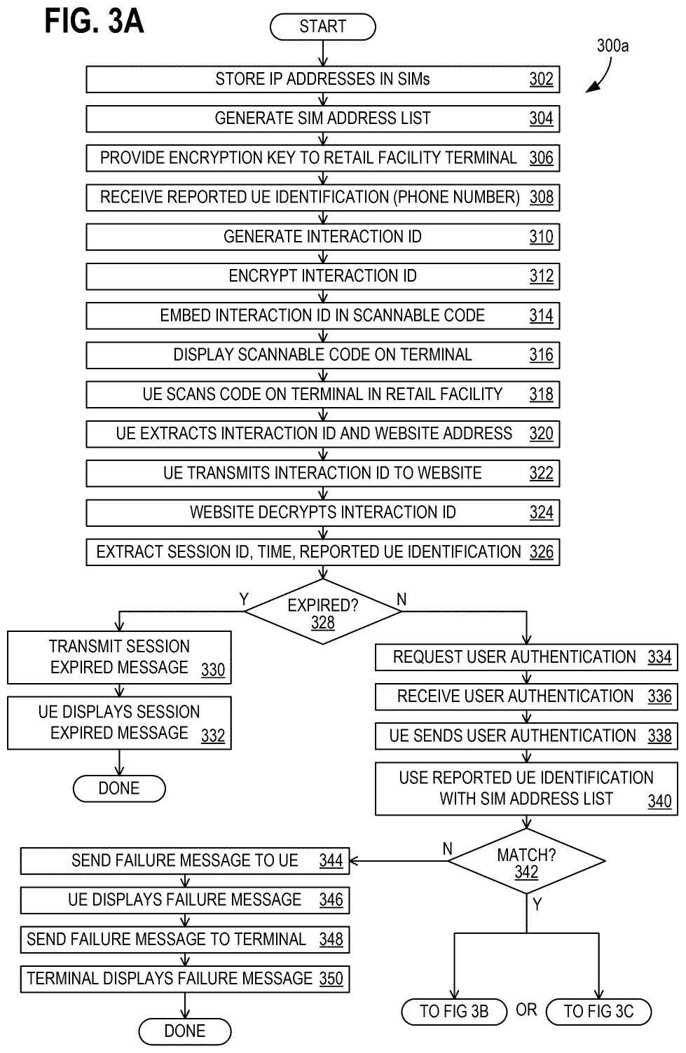

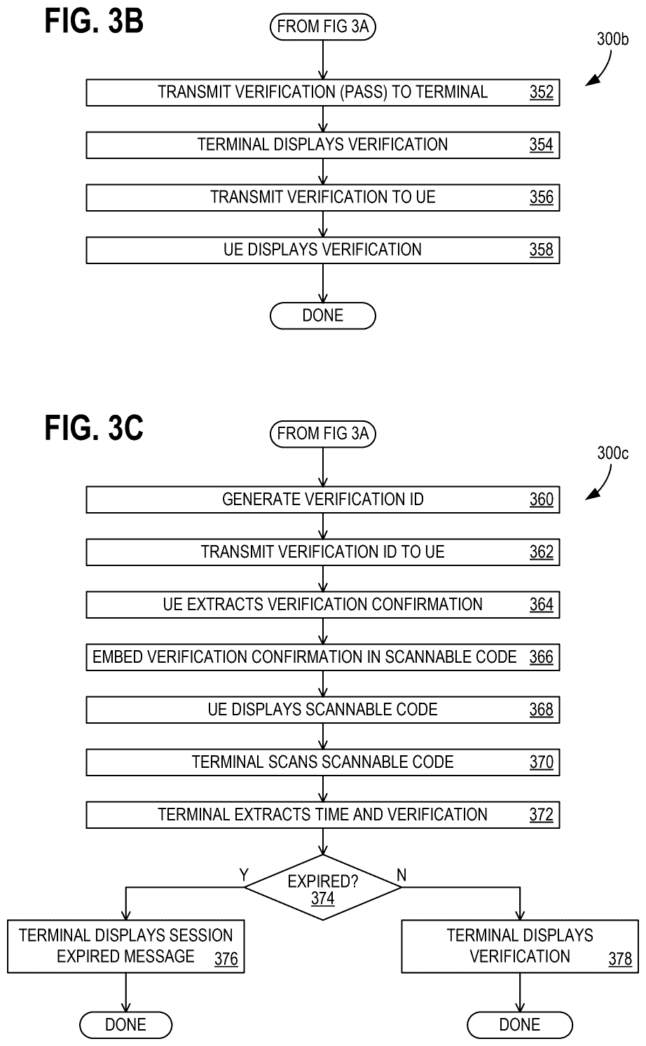

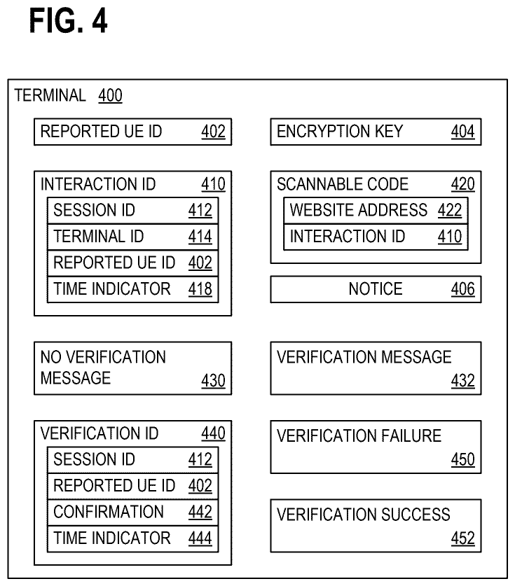

In order to perform the verification, one of the processes described below is performed, starting with flowchart 300a (of FIG. 3A) and then continuing with flowchart 300b (of FIG. 3B), or starting with flowchart 300a and then continuing with flowchart 300c (of FIG. 3C). That is, FIG. 3A illustrates a flowchart 300a of exemplary operations associated with architecture 100; FIG. 3B illustrates a flowchart of exemplary operations associated with a first verification scenario, and which follows the operations of the flowchart of FIG. 3A; and FIG. 3C illustrates a flowchart of exemplary operations associated with an alternative verification scenario, and which also follows the operations of the flowchart of FIG. 3A, in lieu of FIG. 3B; In some examples, at least a portion of flowcharts 300a, 300b, and 300c may be performed using one or more computing devices 900 of FIG. 10.

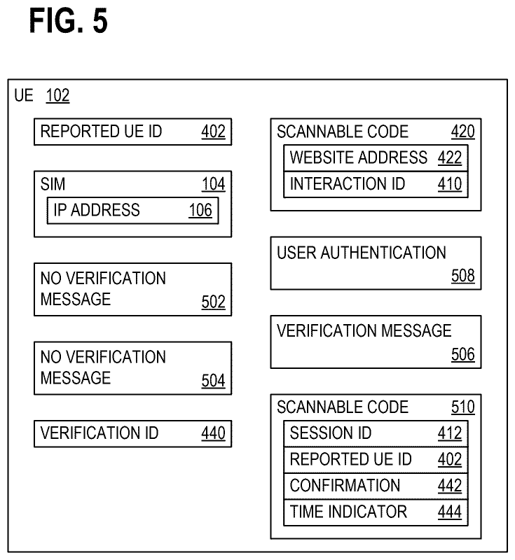

FIGS. 4, 5, and 6 illustrates further detail for terminal 400, UE 102, and verification website 600, respectively. As FIGS. 3A-3C are described, references are made to the details illustrated in one or more of FIGS. 4, 5, and 6 for a respective one of terminal 400, UE 102, and verification website 600.

Flowchart 700 commences with storing stored IP addresses 212 plurality of SIMs 204 (one stored IP address per SIM), in operation 302. SIM address list 210 is generated in operation 304 and associates, for each SIM of plurality of SIMs 204, the stored IP address within the SIM with the stored UE identification. For example, for SIM 104, stored IP address 206 is associated with stored UE identification 208 (e.g., the phone number of UE 102). In some examples, SIM address list 210 includes an ICCID for each SIM of plurality of SIMs 204. See FIG. 2.

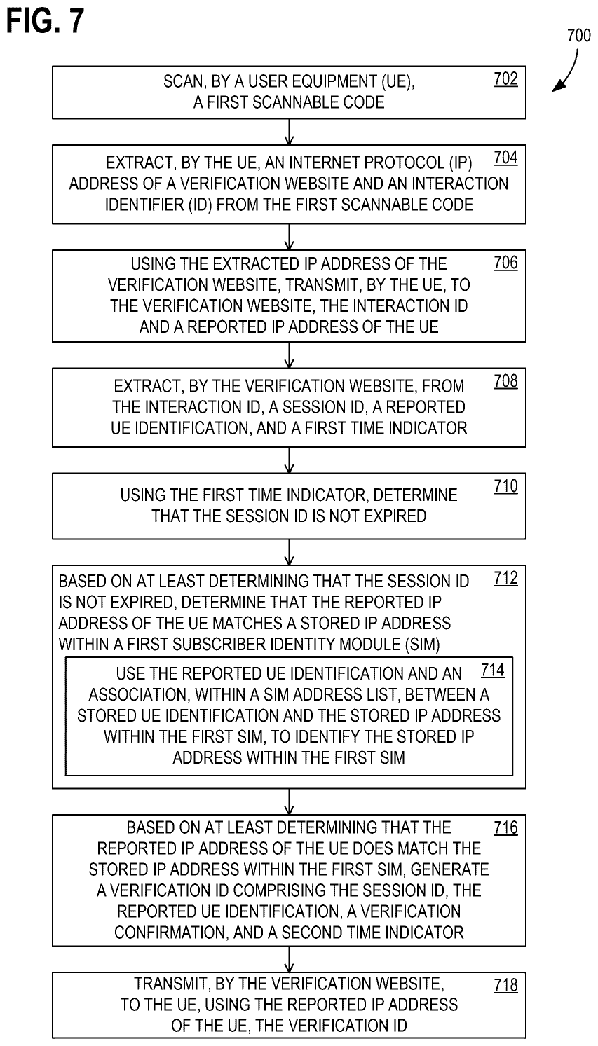

Encryption key 404 is transmitted to terminal 400 in operation 306, so that information encrypted at terminal 400 (which is remote from verification website 600) may be transmitted securely and decrypted at verification website 600. See FIGS. 4 and 6. Some examples may use a public key encryption scheme, in which verification website 600 instead has a decryption key that is different than an encryption key.

UE 102 is brought into retail facility 202 and the purported owner reports a reported UE identification 402 of UE 102 that purportedly contains SIM 104. At this point, it is unknown whether UE 102 is truly associated with reported UE identification 402 or actually contains SIM 104. Terminal 400 receives reported UE identification 402 in operation 308, either as reported by the purported owner and typed into terminal 400, or via an account database lookup. In operation 310, terminal 400 generates interaction ID 410 comprising session ID 412, reported UE identification 402, and time indicator 418. In some examples, interaction ID 410 further comprises terminal identification 414 that identifies terminal 400. See FIG. 4.

Session ID 412 is a unique identifier (possibly alphanumeric) for the interaction with the purported owner of UE 102 and the employee in retail facility 202. In some examples, terminal identification 414 comprises an IP address of terminal 400. In some examples, time indicator 418 comprises a current time and date or a session expiration time and date for the interaction session identified by session ID 412. In operation 312, terminal 400 encrypts interaction ID 410 using encryption key 404.

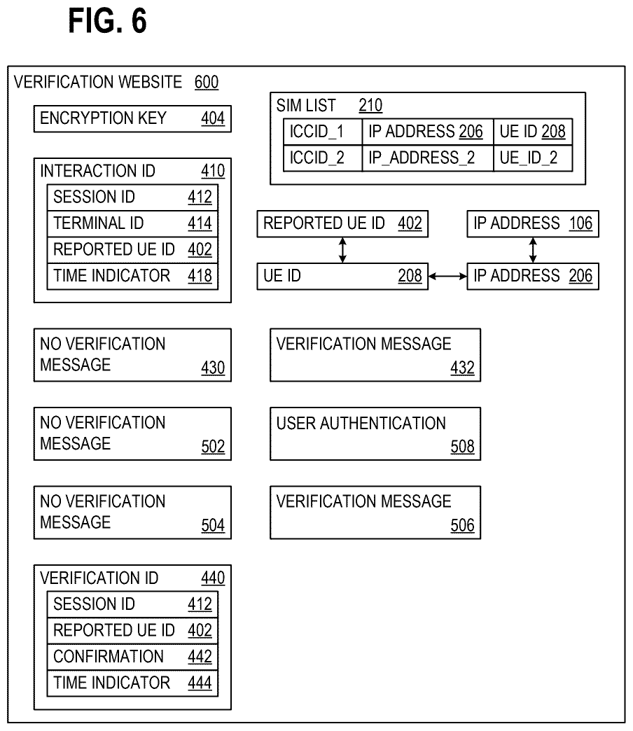

In operation 314, terminal 400 embeds IP address 422 of verification website 600 and (encrypted) interaction ID 410 into scannable code 420. In some examples, scannable code 420 comprises a QR code or a 2D barcode. Scannable code 420 is displayed on terminal 400, in operation 316, where—because UE 102 is physically located within retail facility 202—UE 102 is able to scan scannable code 420 in operation 318. See FIGS. 4 and 5. In some examples, terminal 400 also displays notice 406, alerting the purported owner of UE 102 to turn off WiFi and/or to turn on cellular data. This is because verification website 600 uses the IP address provided with the http request, and if UE 102 is using WiFi, the WiFi router will substitute its own IP address for that of UE 102. To ensure that verification website 600 receives IP address 106 from within SIM 104 inside UE 102, UE 102 needs to use cellular data to reach verification website 600.

UE 102 extracts IP address 422 of verification website 600 and interaction ID 410 from scannable code 420, in operation 320, and using the extracted IP address 422 of verification website 600, transmits (encrypted) interaction ID 410 to verification website 600, along with its own reported IP address 106 (i.e., reported by the internet browser of UE 102) to verification website 600 in operation 322. Verification website 600 decrypts interaction ID 410 in operation 324, and extracts session ID 412, reported UE identification 402, and time indicator 418 from interaction ID 410 in operation 326. See FIG. 6.

In decision operation 328, verification website 600 uses using time indicator 418 to determine whether session ID 412 is expired. If so, then in operation 330, verification website 600 transmits no verification message 502 to UE 102, using reported IP address 106. See FIGS. 5 and 6. No verification message 502 indicates that session ID 412 is expired. UE 102 displays no verification message 502 in operation 332.

Otherwise, if session ID 412 is not expired, verification website 600 requests user authentication from UE 102 in operation 334. UE 102 receives user authentication 508 from the user (e.g., a password, fingerprint, face scan, etc.) in operation 336, and transmits user authentication 508 to verification website 600 in operation 338. See FIGS. 5 and 6.

In operation 340, verification website 600 uses reported UE identification 402 to find stored UE identification 208 in SIM address list 210. Within SIM address list 210, stored UE identification 208 is associated with stored IP address 206. Verification website 600 now has an IP address to compare with reported IP address 106 that UE 102 transmitted to verification website 600 (as described above for operation 322). That is, verification website 600 uses reported UE identification 402 and the association, within SIM address list 210, between stored UE identification 208 and stored IP address 206 within SIM 104, to identify stored IP address 206 within SIM 104. See FIG. 6.

Decision operation 342 uses the results of operation 340 to determine whether reported IP address 106 of UE 102 matches stored IP address 206. If reported IP address 106 of UE 102 does not match stored IP address 206, verification website 600 transmits no verification message 504 to UE 102 in operation 344. UE 102 displays no verification message 504 in operation 346. See FIGS. 5 and 6. This failure is not necessarily an indication of an attempted deception. It could be merely that UE 102 is using WiFi to reach the internet. So, in some examples, no verification message 504 indicates a notice to turn off WiFi and/or to turn on cellular data.

In some examples, verification website 600 also transmits a no verification message 430 to terminal 400 (e.g., using terminal identification 414 extracted from interaction ID 410) in operation 348. No verification message 430 indicates that UE 102 failed a SIM verification, and terminal 400 displays no verification message 430 in operation 350. See FIGS. 4 and 6.

If, however, reported IP address 106 of UE 102 does match stored IP address 206 (as determined in decision operation 342) either the verification process is completed using flowchart 300b of FIG. 3B, or alternatively, using flowchart 300c of FIG. 3C.

Turning first to flowchart 300b of FIG. 3B, based on at least determining that reported IP address 106 of UE 102 does match stored IP address 206, verification website 600 transmits verification message 432 to terminal 400, using terminal identification 414, in operation 352. Verification message 432 indicates that UE 102 passed a SIM verification. Terminal 400 displays verification message 432 in operation 354. See FIGS. 4 and 6.

In some examples, verification website 600 also transmits verification message 506 to UE 102, using reported IP address 106, in operation 356. Verification message 506 indicates that a SIM verification is passed. UE 102 displays verification message 506 in operation 358. See FIGS. 5 and 6.

Turning next to flowchart 300c of FIG. 3C, in operation 360, based on at least determining that reported IP address 106 of UE 102 does match stored IP address 206, verification website 600 generates verification ID 440 comprising session ID 412, reported UE identification 402, verification confirmation 442, and time indicator 444. In some examples, verification confirmation 442 comprises reported UE identification 402 and/or session ID 412. Time indicator 444 may be a current time and date, a verification confirmation expiration time and date, or may match time indicator 418 (forming a time-out for the entirety of session ID 412, from when UE 102 initially scans scannable code 420 until when verification is presented on UE 102 to terminal 400). See FIG. 6. In some examples, some portion(s) or all of verification ID 440 is digitally signed.

In operation 362, verification website 600 transmits verification ID 440 to UE 102, using reported IP address 106. In some examples, UE 102 extracts session ID 412, reported UE identification 402, verification confirmation 442, and time indicator 444 from verification ID 440, in operation 364. UE 102 embeds session ID 412, reported UE identification 402, verification confirmation 442, and time indicator 444 into scannable code 510, in operation 366. In some examples, UE 102 skips operation 364 and embeds verification ID 440 into scannable code 510, as-is, in operation 366. UE 102 displays scannable code 510 in operation 368. See FIG. 5.

Terminal 400 scans scannable code 510 from the display of UE 102 in operation 370, and either extracts session ID 412, reported UE identification 402, verification confirmation 442, and time indicator 444, in operation 372—or—extracts verification ID 440 from scannable code 510 and then extracts session ID 412, reported UE identification 402, verification confirmation 442, and time indicator 444 from verification ID 440. In some examples, there is effectively no difference. In either case, Terminal 400 has the content identified for verification ID 440. See FIG. 4.

In decision operation 374, terminal 400 uses time indicator 444 to determine whether verification confirmation 442 is expired. If verification confirmation 442 is expired, terminal 400 displays verification failure 450 in operation 376, indicating that the verification is stale and will not be accepted. If verification confirmation 442 is not expired, terminal 400 displays verification success message 452 in operation 378, indicating that UE 102 passed a SIM verification. See FIG. 4.

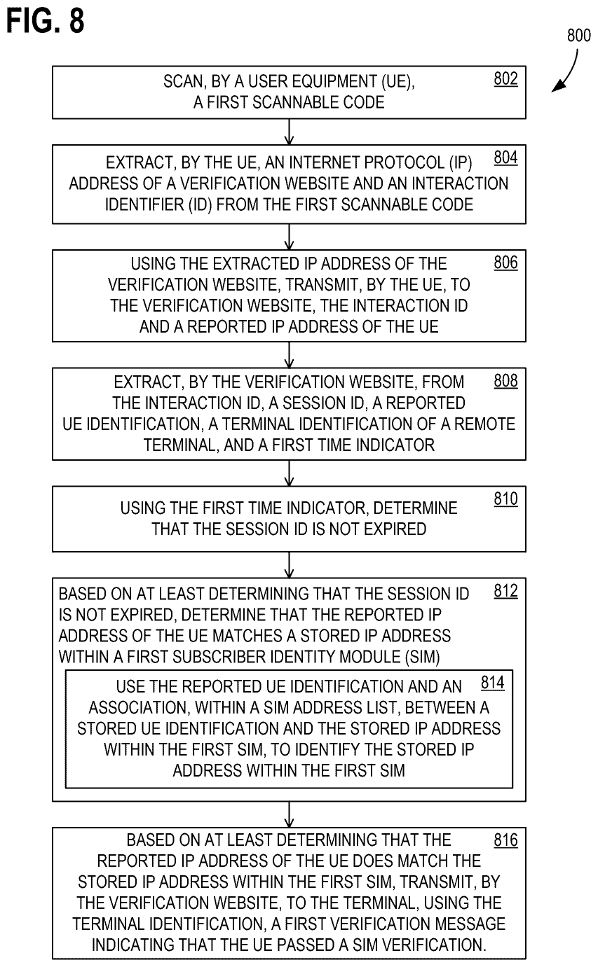

FIG. 7 illustrates a flowchart 700 of exemplary operations associated with architecture 100. In some examples, at least a portion of flowchart 700 may be performed using one or more computing devices 900 of FIG. 9. Flowchart 700 commences with operation 702, which includes scanning, by a UE, a first scannable code. Operation 704 includes extracting, by the UE, an IP address of a verification website and an interaction ID from the first scannable code.

Operation 706 includes using the extracted IP address of the verification website, transmitting, by the UE, to the verification website, the interaction ID and a reported IP address of the UE. Operation 708 includes extracting, by the verification website, from the interaction ID, a session ID, a reported UE identification, and a first time indicator. Operation 710 includes using the first time indicator, determining that the session ID is not expired.

Operation 712 includes, based on at least determining that the session ID is not expired, determining that the reported IP address of the UE matches a stored IP address within a first SIM. Operation 712 is performed using operation 714, which includes using the reported UE identification and an association, within a SIM address list, between a stored UE identification and the stored IP address within the first SIM, to identify the stored IP address within the first SIM. Operation 716 includes, based on at least determining that the reported IP address of the UE does match the stored IP address within the first SIM, generating a verification ID comprising the session ID, the reported UE identification, a verification confirmation, and a second time indicator. Operation 718 includes transmitting, by the verification website, to the UE, using the reported IP address of the UE, the verification ID.

FIG. 8 illustrates a flowchart 800 of exemplary operations associated with examples of architecture 100. In some examples, at least a portion of flowchart 800 may be performed using one or more computing devices 900 of FIG. 9. Flowchart 800 commences with operation 802, which includes scanning, by a UE, a first scannable code. Operation 804 includes extracting, by the UE, an IP address of a verification website and an interaction ID from the first scannable code.

Operation 806 includes using the extracted IP address of the verification website, transmitting, by the UE, to the verification website, the interaction ID and a reported IP address of the UE. Operation 808 includes extracting, by the verification website, from the interaction ID, a session ID, a reported UE identification, a terminal identification of a remote terminal, and a first time indicator. Operation 810 includes using the first time indicator, determining that the session ID is not expired.

Operation 812 includes, based on at least determining that the session ID is not expired, determining whether the reported IP address of the UE matches a stored IP address within a first SIM. Operation 812 is performed using operation 814, which includes using the reported UE identification and an association, within a SIM address list, between a stored UE identification and the stored IP address within the first SIM, to identify the stored IP address within the first SIM. Operation 816 includes, based on at least determining that the reported IP address of the UE does match the stored IP address within the first SIM, transmitting, by the verification website, to the terminal, using the terminal identification, a first verification message indicating that the UE passed a SIM verification.

FIG. 9 illustrates a block diagram of computing device 900 that may be used as any component described herein that may require computational or storage capacity. Computing device 900 has at least a processor 902 and a memory 904 that holds program code 910, data area 920, and other logic and storage 930. Memory 904 is any device allowing information, such as computer executable instructions and/or other data, to be stored and retrieved. For example, memory 904 may include one or more random access memory (RAM) modules, flash memory modules, hard disks, solid-state disks, persistent memory devices, and/or optical disks. Program code 910 comprises computer executable instructions and computer executable components including instructions used to perform operations described herein. Data area 920 holds data used to perform operations described herein. Memory 904 also includes other logic and storage 930 that performs or facilitates other functions disclosed herein or otherwise required of computing device 900. An input/output (I/O) component 940 facilitates receiving input from users and other devices and generating displays for users and outputs for other devices. A network interface 950 permits communication over external network 960 with a remote node 970, which may represent another implementation of computing device 900. For example, a remote node 970 may represent another of the above-noted nodes within architecture 100.

### Additional Examples

An example system comprises: a processor; and a computer-readable medium storing instructions that are operative upon execution by the processor to: scan, by a UE, a first scannable code; extract, by the UE, an IP address of a verification website and an interaction ID from the first scannable code; using the extracted IP address of the verification website, transmit, by the UE, to the verification website, the interaction ID and a reported IP address of the UE; extract, by the verification website, from the interaction ID, a session ID, a reported UE identification, and a first time indicator; using the first time indicator, determine that the session ID is not expired; based on at least determining that the session ID is not expired, determine that the reported IP address of the UE matches a stored IP address within a first SIM, wherein determining that the reported IP address of the UE matches the stored IP address within the first SIM comprises: using the reported UE identification and an association, within a SIM address list, between a stored UE identification and the stored IP address within the first SIM, to identify the stored IP address within the first SIM; based on at least determining that the reported IP address of the UE does match the stored IP address within the first SIM, generate a verification ID comprising the session ID, the reported UE identification, a verification confirmation, and a second time indicator; and transmit, by the verification website, to the UE, using the reported IP address of the UE, the verification ID.

An example method comprises: scanning, by a UE, a first scannable code; extracting, by the UE, an IP address of a verification website and an interaction ID from the first scannable code; using the extracted IP address of the verification website, transmitting, by the UE, to the verification website, the interaction ID and a reported IP address of the UE; extracting, by the verification website, from the interaction ID, a session ID, a reported UE identification, and a first time indicator; using the first time indicator, determining that the session ID is not expired; based on at least determining that the session ID is not expired, determining that the reported IP address of the UE matches a stored IP address within a first SIM, wherein determining that the reported IP address of the UE matches the stored IP address within the first SIM comprises: using the reported UE identification and an association, within a SIM address list, between a stored UE identification and the stored IP address within the first SIM, to identify the stored IP address within the first SIM; based on at least determining that the reported IP address of the UE does match the stored IP address within the first SIM, generating a verification ID comprising the session ID, the reported UE identification, a verification confirmation, and a second time indicator; and transmitting, by the verification website, to the UE, using the reported IP address of the UE, the verification ID.

One or more example computer storage devices has computer-executable instructions stored thereon, which, upon execution by a computer, cause the computer to perform operations comprising: scanning, by a UE, a first scannable code; extracting, by the UE, an IP address of a verification website and an interaction ID from the first scannable code; using the extracted IP address of the verification website, transmitting, by the UE, to the verification website, the interaction ID and a reported IP address of the UE; extracting, by the verification website, from the interaction ID, a session ID, a reported UE identification, and a first time indicator; using the first time indicator, determining that the session ID is not expired; based on at least determining that the session ID is not expired, determining that the reported IP address of the UE matches a stored IP address within a first SIM, wherein determining that the reported IP address of the UE matches the stored IP address within the first SIM comprises: using the reported UE identification and an association, within a SIM address list, between a stored UE identification and the stored IP address within the first SIM, to identify the stored IP address within the first SIM; based on at least determining that the reported IP address of the UE does match the stored IP address within the first SIM, generating a verification ID comprising the session ID, the reported UE identification, a verification confirmation, and a second time indicator; and transmitting, by the verification website, to the UE, using the reported IP address of the UE, the verification ID.

An additional example system comprises: a processor; and a computer-readable medium storing instructions that are operative upon execution by the processor to: scan, by a UE, a first scannable code; extract, by the UE, an IP address of a verification website and an interaction ID from the first scannable code; using the extracted IP address of the verification website, transmit, by the UE, to the verification website, the interaction ID and a reported IP address of the UE; extract, by the verification website, from the interaction ID, a session ID, a reported UE identification, a terminal identification of a remote terminal, and a first time indicator; using the first time indicator, determine that the session ID is not expired; based on at least determining that the session ID is not expired, determine whether the reported IP address of the UE matches a stored IP address within a first SIM, wherein determining whether the reported IP address of the UE matches the stored IP address within the first SIM comprises: use the reported UE identification and an association, within a SIM address list, between a stored UE identification and the stored IP address within the first SIM, to identify the stored IP address within the first SIM; and based on at least determining that the reported IP address of the UE does match the stored IP address within the first SIM, transmit, by the verification website, to the terminal, using the terminal identification, a first verification message indicating that the UE passed a SIM verification.

An additional example method comprises: scanning, by a UE, a first scannable code; extracting, by the UE, an IP address of a verification website and an interaction ID from the first scannable code; using the extracted IP address of the verification website, transmitting, by the UE, to the verification website, the interaction ID and a reported IP address of the UE; extracting, by the verification website, from the interaction ID, a session ID, a reported UE identification, a terminal identification of a remote terminal, and a first time indicator; using the first time indicator, determining that the session ID is not expired; based on at least determining that the session ID is not expired, determining whether the reported IP address of the UE matches a stored IP address within a first SIM, wherein determining whether the reported IP address of the UE matches the stored IP address within the first SIM comprises: using the reported UE identification and an association, within a SIM address list, between a stored UE identification and the stored IP address within the first SIM, to identify the stored IP address within the first SIM; and based on at least determining that the reported IP address of the UE does match the stored IP address within the first SIM, transmitting, by the verification website, to the terminal, using the terminal identification, a first verification message indicating that the UE passed a SIM verification.

One or more example computer storage devices has computer-executable instructions stored thereon, which, upon execution by a computer, cause the computer to perform operations comprising: scanning, by a UE, a first scannable code; extracting, by the UE, an IP address of a verification website and an interaction ID from the first scannable code; using the extracted IP address of the verification website, transmitting, by the UE, to the verification website, the interaction ID and a reported IP address of the UE; extracting, by the verification website, from the interaction ID, a session ID, a reported UE identification, a terminal identification of a remote terminal, and a first time indicator; using the first time indicator, determining that the session ID is not expired; based on at least determining that the session ID is not expired, determining whether the reported IP address of the UE matches a stored IP address within a first SIM, wherein determining whether the reported IP address of the UE matches the stored IP address within the first SIM comprises: using the reported UE identification and an association, within a SIM address list, between a stored UE identification and the stored IP address within the first SIM, to identify the stored IP address within the first SIM; and based on at least determining that the reported IP address of the UE does match the stored IP address within the first SIM, transmitting, by the verification website, to the terminal, using the terminal identification, a first verification message indicating that the UE passed a SIM verification.

Alternatively, or in addition to the other examples described herein, examples include any combination of the following:
the wireless network comprises a cellular network;
the UE comprises an eMBB or cellular telephone, or an FWA;
extracting, by the UE, from the verification ID, the session ID, the reported UE identification, the verification confirmation, and the second time indicator;
embedding, by the UE, into a second scannable code, the session ID, the reported UE identification, the verification confirmation, and the second time indicator;
displaying, by the UE, the second scannable code;
scanning, by a terminal, the second scannable code;
extracting the session ID, the reported UE identification, the verification confirmation, and the second time indicator;
using the second time indicator, determining whether the verification confirmation is expired;
based on at least determining that the verification confirmation is not expired, displaying, by the terminal, a verification success message indicating that the UE passed a SIM verification;
based on at least determining that the verification confirmation is expired, displaying, by the terminal, a verification failure message;
using the first time indicator, determining whether the session ID is expired;
based on at least determining that the session ID is expired, transmitting, by the verification website, to the UE, using the reported IP address of the UE, a first no verification message;
based on at least determining that the session ID is expired, displaying, by the UE, the first no verification message;
determining whether the reported IP address of the UE matches the stored IP address within the first SIM;
based on at least determining that the reported IP address of the UE does not match the stored IP address within the first SIM, transmitting, by the verification website, to the UE, using the reported IP address of the UE, a second no verification message;
based on at least determining that the reported IP address of the UE does not match the stored IP address within the first SIM, displaying, by the UE, the second no verification message;
based on at least determining that the reported IP address of the UE does not match the stored IP address within the first SIM, transmitting, by the verification website, to the terminal, using the terminal identification, a third no verification message indicating that the UE failed a SIM verification;
based on at least determining that the reported IP address of the UE does not match the stored IP address within the first SIM, displaying, by the terminal, the third no verification message;
storing, in each SIM of a plurality of SIMs, a stored IP address, the plurality of SIMs including the first SIM, wherein each stored IP address is unique;
generating the SIM address list associating, for each SIM of the plurality of SIMs, the stored IP address within the SIM with a stored UE identification, wherein the stored UE identification comprises a phone number, and wherein the reported UE identification comprises a phone number;
receiving, by the terminal, the reported UE identification of the UE, the UE purportedly containing the first SIM;
generating, by the terminal, the interaction ID comprising the session ID, the reported UE identification, and the first time indicator;
generating, by the terminal, the interaction ID comprising the session ID, the reported UE identification, the terminal identification, and the first time indicator;
embedding the IP address of the verification website and the interaction ID into the first scannable code;
displaying, on the terminal, the first scannable code;
transmitting an encryption key to the terminal;
encrypting the interaction ID using the encryption key, wherein embedding the encrypted interaction ID into the first scannable code comprises embedding the encrypted interaction ID into the first scannable code;
decrypting, by the verification website, the interaction ID;
requesting, by the verification website, user authentication from the UE;
receiving user authentication by the UE;
transmitting, by the UE, to the verification website, the user authentication, wherein determining whether the reported IP address of the UE matches the stored IP address within the first SIM is further based on at least the verification website receiving user authentication from the UE;
displaying, by the terminal, the first verification message;
transmitting, by the verification website, to the UE, using the reported IP address of the UE, a second verification message indicating that a SIM verification is passed;
displaying, by the UE, the second verification message;
the SIM address list includes an ICCID for each SIM of the plurality of SIMs;
the terminal identification comprises an IP address of the terminal;
the first time indicator comprises a current time and date;
the first time indicator comprises a session expiration time and date;
the verification website generates the verification ID;
the second time indicator matches the first time indicator;
the second time indicator comprises a current time and date;
the second time indicator comprises a verification confirmation expiration time and date;
the verification confirmation comprises the reported UE identification and/or the session ID;
the verification is digitally signed; and
the terminal extracts the session ID, the reported UE identification, the verification confirmation, and the second time indicator.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
scanning, by a user equipment (UE), a first scannable code;
extracting, by the UE, an internet protocol (IP) address of a verification website and an interaction identifier (ID) from the first scannable code;
using the extracted IP address of the verification website, transmitting, by the UE, to the verification website, the interaction ID and a reported IP address of the UE;
extracting, by the verification website, from the interaction ID, a session ID, a reported UE identification, and a first time indicator;
using the first time indicator, determining that the session ID is not expired;
based on at least determining that the session ID is not expired, determining that the reported IP address of the UE matches a stored IP address within a first subscriber identity module (SIM), wherein determining that the reported IP address of the UE matches the stored IP address within the first SIM comprises:
using the reported UE identification and an association, within a SIM address list, between a stored UE identification and the stored IP address within the first SIM, to identify the stored IP address within the first SIM;
based on at least determining that the reported IP address of the UE does match the stored IP address within the first SIM, generating a verification ID comprising the session ID, the reported UE identification, a verification confirmation, and a second time indicator; and
transmitting, by the verification website, to the UE, using the reported IP address of the UE, the verification ID.

2. The method of claim 1, further comprising:
extracting, by the UE, from the verification ID, the session ID, the reported UE identification, the verification confirmation, and the second time indicator;
embedding, by the UE, into a second scannable code, the session ID, the reported UE identification, the verification confirmation, and the second time indicator;
displaying, by the UE, the second scannable code;
scanning, by a terminal, the second scannable code;
extracting the session ID, the reported UE identification, the verification confirmation, and the second time indicator;
using the second time indicator, determining whether the verification confirmation is expired; and
either:
based on at least determining that the verification confirmation is not expired, displaying, by the terminal, a verification success message indicating that the UE passed a SIM verification; or
based on at least determining that the verification confirmation is expired, displaying, by the terminal, a verification failure message.

3. The method of claim 2, further comprising:
either:
using the first time indicator, determining whether the session ID is expired; and
based on at least determining that the session ID is expired:
transmitting, by the verification website, to the UE, using the reported IP address of the UE, a first no verification message; and
displaying, by the UE, the first no verification message; or
determining whether the reported IP address of the UE matches the stored IP address within the first SIM; and
based on at least determining that the reported IP address of the UE does not match the stored IP address within the first SIM:
transmitting, by the verification website, to the UE, using the reported IP address of the UE, a second no verification message; and
displaying, by the UE, the second no verification message.

4. The method of claim 1, further comprising:
storing, in each SIM of a plurality of SIMs, a stored IP address, the plurality of SIMs including the first SIM, wherein each stored IP address is unique; and
generating the SIM address list associating, for each SIM of the plurality of SIMs, the stored IP address within the SIM with a stored UE identification, wherein the stored UE identification comprises a phone number, and wherein the reported UE identification comprises a phone number.

5. The method of claim 1, further comprising:
receiving, by a terminal, the reported UE identification of the UE, the UE purportedly containing the first SIM;
generating, by the terminal, the interaction ID comprising the session ID, the reported UE identification, and the first time indicator;
embedding the IP address of the verification website and the interaction ID into the first scannable code; and
displaying, on the terminal, the first scannable code.

6. The method of claim 5, further comprising:
transmitting an encryption key to the terminal;
encrypting the interaction ID using the encryption key, wherein embedding the encrypted interaction ID into the first scannable code comprises embedding the encrypted interaction ID into the first scannable code; and
decrypting, by the verification website, the interaction ID.

7. The method of claim 1, further comprising:
requesting, by the verification website, user authentication from the UE;
receiving user authentication by the UE; and
transmitting, by the UE, to the verification website, the user authentication, wherein determining whether the reported IP address of the UE matches the stored IP address within the first SIM is further based on at least the verification website receiving user authentication from the UE.

8. A system comprising:
a processor; and
a computer-readable medium storing instructions that are operative upon execution by the processor to:
scan, by a user equipment (UE), a first scannable code;
extract, by the UE, an internet protocol (IP) address of a verification website and an interaction identifier (ID) from the first scannable code;
using the extracted IP address of the verification website, transmit, by the UE, to the verification website, the interaction ID and a reported IP address of the UE;
extract, by the verification website, from the interaction ID, a session ID, a reported UE identification, and a first time indicator;
using the first time indicator, determine that the session ID is not expired;
based on at least determining that the session ID is not expired, determine that the reported IP address of the UE matches a stored IP address within a first subscriber identity module (SIM), wherein determining that the reported IP address of the UE matches the stored IP address within the first SIM comprises:
using the reported UE identification and an association, within a SIM address list, between a stored UE identification and the stored IP address within the first SIM, to identify the stored IP address within the first SIM;
based on at least determining that the reported IP address of the UE does match the stored IP address within the first SIM, generate a verification ID comprising the session ID, the reported UE identification, a verification confirmation, and a second time indicator; and
transmit, by the verification website, to the UE, using the reported IP address of the UE, the verification ID.

9. The system of claim 8, wherein the instructions are further operative to:
extract, by the UE, from the verification ID, the session ID, the reported UE identification, the verification confirmation, and the second time indicator;
embed, by the UE, into a second scannable code, the session ID, the reported UE identification, the verification confirmation, and the second time indicator;
display, by the UE, the second scannable code;
scan, by a terminal, the second scannable code;
extract the session ID, the reported UE identification, the verification confirmation, and the second time indicator;
using the second time indicator, determine whether the verification confirmation is expired; and
either:
based on at least determining that the verification confirmation is not expired, display, by the terminal, a verification success message indicating that the UE passed a SIM verification; or
based on at least determining that the verification confirmation is expired, display, by the terminal, a verification failure message.

10. The system of claim 9, wherein the instructions are further operative to:
either:
using the first time indicator, determine whether the session ID is expired; and
based on at least determining that the session ID is expired:
transmit, by the verification website, to the UE, using the reported IP address of the UE, a first no verification message; and
display, by the UE, the first no verification message; or
determine whether the reported IP address of the UE matches the stored IP address within the first SIM; and
based on at least determining that the reported IP address of the UE does not match the stored IP address within the first SIM:
transmit, by the verification website, to the UE, using the reported IP address of the UE, a second no verification message; and
display, by the UE, the second no verification message.

11. The system of claim 8, wherein the instructions are further operative to:
store, in each SIM of a plurality of SIMs, a stored IP address, the plurality of SIMs including the first SIM, wherein each stored IP address is unique; and
generate the SIM address list associating, for each SIM of the plurality of SIMs, the stored IP address within the SIM with a stored UE identification, wherein the stored UE identification comprises a phone number, and wherein the reported UE identification comprises a phone number.

12. The system of claim 8, wherein the instructions are further operative to:
receive, by a terminal, the reported UE identification of the UE, the UE purportedly containing the first SIM;
generate, by the terminal, the interaction ID comprising the session ID, the reported UE identification, and the first time indicator;
embed the IP address of the verification website and the interaction ID into the first scannable code; and
display, on the terminal, the first scannable code.

13. The system of claim 12, wherein the instructions are further operative to:
transmit an encryption key to the terminal;
encrypt the interaction ID using the encryption key, wherein embedding the encrypted interaction ID into the first scannable code comprises embedding the encrypted interaction ID into the first scannable code; and
decrypt, by the verification website, the interaction ID.

14. The system of claim 8, wherein the instructions are further operative to:
request, by the verification website, user authentication from the UE;
receive user authentication by the UE; and
transmit, by the UE, to the verification website, the user authentication, wherein determining whether the reported IP address of the UE matches the stored IP address within the first SIM is further based on at least the verification website receiving user authentication from the UE.

15. One or more computer storage devices having computer-executable instructions stored thereon, which, upon execution by a computer, cause the computer to perform operations comprising:
scanning, by a user equipment (UE), a first scannable code;
extracting, by the UE, an internet protocol (IP) address of a verification website and an interaction identifier (ID) from the first scannable code;
using the extracted IP address of the verification website, transmitting, by the UE, to the verification website, the interaction ID and a reported IP address of the UE;
extracting, by the verification website, from the interaction ID, a session ID, a reported UE identification, and a first time indicator;
using the first time indicator, determining that the session ID is not expired;
based on at least determining that the session ID is not expired, determining that the reported IP address of the UE matches a stored IP address within a first subscriber identity module (SIM), wherein determining that the reported IP address of the UE matches the stored IP address within the first SIM comprises:
using the reported UE identification and an association, within a SIM address list, between a stored UE identification and the stored IP address within the first SIM, to identify the stored IP address within the first SIM;
based on at least determining that the reported IP address of the UE does match the stored IP address within the first SIM, generating a verification ID comprising the session ID, the reported UE identification, a verification confirmation, and a second time indicator; and
transmitting, by the verification website, to the UE, using the reported IP address of the UE, the verification ID.

16. The one or more computer storage devices of claim 15, wherein the operations further comprise:
extracting, by the UE, from the verification ID, the session ID, the reported UE identification, the verification confirmation, and the second time indicator;
embedding, by the UE, into a second scannable code, the session ID, the reported UE identification, the verification confirmation, and the second time indicator;
displaying, by the UE, the second scannable code;
scanning, by a terminal, the second scannable code;
extracting the session ID, the reported UE identification, the verification confirmation, and the second time indicator;
using the second time indicator, determining whether the verification confirmation is expired; and
either:
based on at least determining that the verification confirmation is not expired, displaying, by the terminal, a verification success message indicating that the UE passed a SIM verification; or
based on at least determining that the verification confirmation is expired, displaying, by the terminal, a verification failure message.

17. The one or more computer storage devices of claim 16, wherein the operations further comprise:
either:
using the first time indicator, determining whether the session ID is expired; and
based on at least determining that the session ID is expired:
transmitting, by the verification website, to the UE, using the reported IP address of the UE, a first no verification message; and
displaying, by the UE, the first no verification message; or
determining whether the reported IP address of the UE matches the stored IP address within the first SIM; and
based on at least determining that the reported IP address of the UE does not match the stored IP address within the first SIM:
transmitting, by the verification website, to the UE, using the reported IP address of the UE, a second no verification message; and
displaying, by the UE, the second no verification message.

18. The one or more computer storage devices of claim 15, wherein the operations further comprise:
storing, in each SIM of a plurality of SIMs, a stored IP address, the plurality of SIMs including the first SIM, wherein each stored IP address is unique; and
generating the SIM address list associating, for each SIM of the plurality of SIMs, the stored IP address within the SIM with a stored UE identification, wherein the stored UE identification comprises a phone number, and wherein the reported UE identification comprises a phone number.

19. The one or more computer storage devices of claim 15, wherein the operations further comprise:
receiving, by a terminal, the reported UE identification of the UE, the UE purportedly containing the first SIM;
generating, by the terminal, the interaction ID comprising the session ID, the reported UE identification, and the first time indicator;
embedding the IP address of the verification website and the interaction ID into the first scannable code; and
displaying, on the terminal, the first scannable code.

20. The one or more computer storage devices of claim 19, wherein the operations further comprise:
transmitting an encryption key to the terminal;
encrypting the interaction ID using the encryption key, wherein embedding the encrypted interaction ID into the first scannable code comprises embedding the encrypted interaction ID into the first scannable code; and
decrypting, by the verification website, the interaction ID.
